(19) United States
(12) Patent Application Publication
(10) Pub. No.: US 2013/0166358 A1
(43) Pub. Date: Jun. 27, 2013

(54) DETERMINING A LIKELIHOOD THAT EMPLOYMENT OF AN EMPLOYEE WILL END

(71) Applicants: Sanjay Parmar, Redwood City, CA (US); Yathish Sarathy, Fremont, CA (US); Madhukar Govindaraju, Cupertino, CA (US)

(72) Inventors: Sanjay Parmar, Redwood City, CA (US); Yathish Sarathy, Fremont, CA (US); Madhukar Govindaraju, Cupertino, CA (US)

(73) Assignee: Saba Software, Inc., Redwood Shores, CA (US)

(21) Appl. No.: 13/725,013

(22) Filed: Dec. 21, 2012

Related U.S. Application Data
(60) Provisional application No. 61/578,420, filed on Dec. 21, 2011.

(51) Int. Cl. G06Q 10/06

(52) U.S. Cl. CPC G06Q 10/06393
USPC 705/7.39

(57) ABSTRACT

Techniques for determining whether employment of an employee will end, such as determining a risk of attrition for an employee. In some embodiments, one or more types of employment information for an employee may be evaluated and weighted to determine a likelihood that employment of the employee will end. Types of employment information that may be evaluated may include interaction information relating to a manner in which an employee interacts with coworkers, including a manner in which an employee is detected to use one or more software tools to interact with coworkers. Types of employment information that may be evaluated may include performance information, which may include performance ratings of an employee and information regarding an employee's capability to perform in the position. Types of employment information may include career path information, which may include employment history information for an employee and/or market information indicating job opportunities in the industry.

### CROSS-REFERENCE TO RELATED APPLICATIONS

The present application claims priority under 35 U.S.C. §119(e) to U.S. Provisional Patent Application No. 61/578,420, filed Dec. 21, 2011, and titled “Methods and Apparatus for Predicting Employee Attrition,” which is incorporated herein by reference in its entirety.

### BACKGROUND OF INVENTION

1. Field of Invention

The techniques described herein are directed generally to the field of employee management, and more particularly to techniques for determining a likelihood that employment of an employee by an employer will end. Some techniques described herein may be used to determine whether an employee will voluntarily end employment by evaluating a variety of numeric values, where each of the numeric values relates to employment information for the employee.

2. Description of the Related Art

Corporations, companies, persons, or other organizations or entities (hereafter referred to as “employers”) that hire significant numbers of employees may implement a system to manage those employees. This service may be performed by a Human Resources (HR) department that is charged with ensuring that the employer is sufficiently staffed to efficiently conduct its business on a day-to-day basis. This may involve hiring employees, establishing and disbursing appropriate compensation and benefits, conducting performance reviews, monitoring employee absences and withdrawals, and terminating employees as necessary. Typically these HR tasks are performed by a staff of personnel (themselves employees) who bring their human experience and training to bear on monitoring employees and taking necessary actions to ensure that the organization is efficiently and consistently staffed.

### SUMMARY

In one embodiment, there is provided a method of determining a likelihood that employment of an employee by an employer will end. The method comprises operating at least one programmed processor to carry out acts of retrieving, from at least one data store, information regarding interaction by the employee with one or more other employees of the employer, retrieving, from the at least one data store, information regarding performance of the employee, and calculating a numeric value indicating the likelihood that the employment of the employee will end. The calculating comprises calculating the numeric value based at least in part on the information regarding the interaction by the employee and the information regarding the performance of the employee. The method further comprises comparing the numeric value to at least one threshold and outputting, based on a result of the comparing, a prediction of whether the employment of the employee will end.

In another embodiment, there is provided at least one computer-readable storage medium having encoded thereon computer-executable instructions that, when executed by at least one computing device, cause the at least one computing device to carry out a method. The method comprises calculating a numeric likelihood that an employee will voluntarily end employment with an employer. The calculating comprises weighting a plurality of numeric values according to a plurality of associated weighting factors to determine a plurality of weighted numeric values and summing the plurality of weighted numeric values, wherein each of the plurality of numeric values relates to employment information for the employee. The method further comprises comparing the numeric likelihood to a threshold and outputting, based on a result of the comparing, a prediction of whether the employee will end employment with the employer.

In a further embodiment, there is provided an apparatus comprising at least one processor and at least one storage medium having encoded thereon executable instructions that, when executed by the at least one processor, cause the at least one processor to carry out a method. The method comprises calculating a numeric value indicative of a likelihood that employment of an employee by an employer will end, comparing the numeric value to a threshold, and outputting, based on a result of the comparing, a prediction of whether the employment by the employee will end.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustrating an exemplary operating environment for a system in accordance with some embodiments;

FIG. 2 is a flowchart of an example of a process that may be used to determine a likelihood that employment of an employee will end;

FIG. 3 is a flowchart of an example of a process that evaluates various types of employment information for an employee to determine a likelihood that employment of the employee will end;

FIG. 4 is a flowchart of an example of a process for calculating a numeric value that is indicative of a type of employment information;

FIG. 5 is a flowchart of an example of a process for configuring an attrition predictor with one or more weighting factors to be used in determining a likelihood that employment of an employee will end;

FIG. 6 is a flowchart of an example of a process for temporarily reconfiguring an attrition predictor with one or more weighting factors to be used in determining a likelihood that employment of an employee will end;

FIG. 7 is a flowchart of an example of a process for presenting attrition information for one or more employees to a user; and

FIG. 8 is a block diagram illustrating an exemplary computer system in which some embodiments may be implemented.

### DETAILED DESCRIPTION

The inventors have recognized and appreciated that employee retention is one of the most burdensome challenges faced by employers in terms of human resources (HR) management. Once an employer has invested significant time and resources in hiring and training an employee, it is in the employer's best interest to take measures to retain that person as an employee of the employer. There may be a high cost to the employer if the employment ends (whether voluntarily, through quitting, or involuntarily, through termination) and a new employee must be found, hired, and trained as a replacement. In addition, an employee who leaves to take a position at a new employer (perhaps a competitor to the prior employer) may pose an undesirable risk in terms of appropriation of the prior employer's intellectual property and migration of skills that the prior employer has cultivated through its own investment in training. In a competitive landscape, labor (especially skilled labor) is capital, and it may behoove an employer to protect its investment in that capital by keeping employees engaged and satisfied, and by proactively averting attrition.

The inventors have also recognized and appreciated that despite the importance of employee retention, there are no tools available to assist HR departments, supervisors, or others in determining whether employment of an employee will end. Conventional methods for recognizing risks and signs of employee attrition have been ad hoc and often ineffective. As a result, when employment of an employee ends, such as when an employee decides to quit or when an employer suddenly learns, such as during a periodic (e.g., annual) review process or other time, that termination is warranted, it may come as a surprise to the employer. The inventors have recognized and appreciated that employers were conventionally limited in their ability to determine a likelihood that employment would end because employers conventionally focus on limited amounts of aggregate data when evaluating employees. Data that employers collected regarding individual employees was often limited to annual performance reviews and compensation levels. The inventors have recognized and appreciated that such information, by itself, may be too sparse and uninformative for an employee, and the implications too variable from employee to employee, for this information to be accurately predictive of whether employment of the employee will end.

The inventors have recognized and appreciated, however, that while the end of employment of an employee may come as a surprise to a supervisor or HR department, the employee's close coworkers may have noticed signs that the employee had been struggling or had been disengaging from the work. More particularly, the inventors have recognized and appreciated that the manner in which an employee interacts with the employee's coworkers may be different for an employee for whom employment may end soon than as compared to an employee for whom employment will not end soon. Employees who are trending toward departure from an organization may create a number of clues to that trend in their electronic interactions with coworkers, such as in their use of computer-based productivity tools available in the employer's enterprise computer environment. For example, an employee for whom employment will end may use the tools less frequently than an employee for whom employment will not end. The inventors have recognized and appreciated that, by intelligently monitoring and correlating an employee's interactions and use of these productivity tools, the clues can be detected and the risk of employment ending may be quantified.

In addition, the inventors have recognized and appreciated that clues to whether employment of an employee will end may be determined from career path information for an employee. Career path information may include information relating to a career history of the employee and/or potential career future of the employee. For example, an employee's career history may indicate that the employee typically remains with the same employer for two years before moving to a new employer. By evaluating an employee's tenure with an employer based on this career history information, clues to whether the employment of the employee by the employer is likely to end may be determined and used to quantify a likelihood. As another example, by evaluating an employee's career opportunities, which may include both opportunities within the employer and opportunities at other employers, clues regarding whether employment may end may be determined. For example, if the employee is determined to have a large number of opportunities outside of the employer, the employee may be determined to be more likely to end employment. Additionally or alternatively, if the employee is determined to have a large number of opportunities for employment with the employer, the employee may be determined to be less likely to end employment. The inventors have recognized and appreciated that, by evaluating career path information for an employee, clues to whether employment will end can be detected and the risk of employment ending may be quantified.

Further, the inventors have recognized and appreciated that clues to whether employment of an employee will end may be determined from information indicating a performance of the employee. Such performance information may include information relating to supervisors' and/or peers' ratings of an employee's performance and may include information regarding trends in performance, such as a comparison of recent performance to prior performance. The inventors have recognized and appreciated that employment of an employee whose performance ratings are low or lower than previous ratings is more likely to end than employment of an employee whose ratings are high or higher than previous ratings. Additionally or alternatively, such performance information may include information relating to an employee's ability to perform the employee's job. Information on the employee's ability to perform may include information regarding an employee's qualifications. Qualification information may include, for example, information regarding an employee's skills relative to requirements of the employee's job. Performance information may also include information regarding whether an employee has obtained certifications and/or licenses that the employee is required by the employer to obtain. The inventors have recognized and appreciated that employment of an employee whose skills are insufficient for a position or who has not obtained necessary certifications/licenses may be more likely to end than employment of an employee whose skills are sufficient for the position or who has all necessary certifications/licenses. In some embodiments, an employer may have provided one or more software tools to employees for the employees to use to obtain certifications and/or licenses or otherwise engage in training and/or skill development. In some such embodiments, employees' use of these software tools may be monitored and information regarding the use may be used in determining a likelihood that employment will end. For example, an employee who is not using the software tools to engage in training and/or skill development may not be committed to the employment. As another example, an employee who is using the software tools on a schedule that is unacceptable to the employer, such as infrequently or past deadlines imposed by the employer, may not be committed to the employment. Accordingly, information regarding the employee's performance, including the employee's use of software tools related to performance, may be evaluated to determine clues to whether employment will end. A risk of employment ending may then be quantified based on these clues.

The inventors have also recognized and appreciated the advantages of a computer-based system for calculating a detailed and quantitative determination of a likelihood that employment of an employee will end. Such a system, executing on one or more computing devices to retrieve data from and write data to one or more electronic data stores, may allow for HR personnel to proactively intervene to prevent employee attrition where it is likely to occur. The system may therefore produce significant benefits for the employer in terms of protecting its investment in existing employees and their skills and training, as well as for the employee in terms of job stability and satisfaction as well as training and skill set development.

In view of the foregoing, described herein are various embodiments of a system, executing on one or more computing devices, that makes a quantitative determination of whether employment will end based on employment information for the employee, where the employment information may be in the form of one or more numeric values. In examples described below, the system may determine a numeric value for each of one or more types of employment information. The system may then weight the numeric values by weighting factors that correspond to types of employment information and may sum the weighted numeric values. The weighted sum may then, in some embodiments, be used as the likelihood that employment of the employee will end. In some embodiments, the system may then compare the likelihood to a threshold and, if the likelihood exceeds the threshold, the system may determine that the employment is likely to end.

Employment information that may be evaluated in embodiments may include one or more types of information regarding an employee's past employment, current employment, or potential future employment. Employment information may include information characterizing the employee's conduct during past or current employment. In embodiments, any suitable employment information or any suitable combination of types of employment information may be evaluated, as embodiments are not limited in this respect. As examples of employment information, in some embodiments a system may make the quantitative determination regarding likelihood that employment will end based on numeric values indicative of the employee's interactions with coworkers, numeric values indicative of the employee's performance, and/or numeric values indicative of the employee's career path.

Numeric values indicative of employment information for an employee may be calculated in any suitable manner. The numeric values may be calculated based on employment information available in and retrieved from one or more electronic data sets, such as one or more databases. Such data sets may include one or more data sets electronically maintained by the employer and/or one or more data sets electronically maintained external to the employer. The system may retrieve employment information and/or numeric values from such data sets over one or more computer networks, including a local area network (LAN) and/or the Internet. In particular, in some embodiments, the system may retrieve numeric values that are indicative of employment information in the data sets, while in other embodiments, the system may additionally or alternatively retrieve employment information from one or more data sets and calculate numeric values indicative of the employment information. Numeric values may be calculated based on employment information in any suitable manner, as embodiments are not limited in this respect. The manner in which numeric values are determined from employment information may, in some cases, differ between types of employment information. Examples of manners in which numeric values may be calculated from employment information are discussed below.

Based on the numeric values, the system may calculate a likelihood that employment of the employee will end. The system may calculate the likelihood in any suitable manner, as embodiments are not limited in this respect. For example, the system may calculate the likelihood as a weighted sum of the numeric values, such as by weighting each numeric value by a weighting factor and summing the resulting weighted numeric values. Each weighting factor corresponding to a numeric value may be indicative of a strength of the corresponding numeric value (and the related employment information) in predicting whether employment will end. The weighted sum calculated by the system may therefore account for each of the numeric values, each related to a type of employment information that may be indicative of a likelihood that employment may end, in proportion to how strongly the related type of employment information correlates to a likelihood that employment will end.

Once the system calculates the likelihood, the likelihood may be compared to one or more threshold likelihoods and a prediction of whether employment will end may be determined based on the result of the comparison. For example, if the calculated likelihood for an employee is above a threshold, the system may predict that employment of the employee will end. Conversely, if the likelihood is below the threshold, the system may conclude that employment of the employee is not likely to end. The prediction of whether employment for the employee will end may then be stored in an electronic data store and/or output to any suitable user, such as a supervisor or member of an HR department.

Described below are illustrative examples of systems for determining a likelihood that employment of an employee will end and techniques that may be implemented by some such systems. For example, in some examples described below, an employee attrition prediction system determines a likelihood of an employee voluntarily ending employment with an employer. Attrition prediction systems described in the examples below may automatically predict employee attrition through the monitoring of a number of factors determined to be informative for an employee's tendency toward leaving the employer organization, including one or more types of employment information for an employee. Information for some or all of the factors may be discoverable through electronically stored information regarding the employee, such as information stored in data sets maintained by the employer and/or others. Any suitable employment information may be processed by attrition prediction systems operating in accordance with one or more of the examples below, as embodiments are not limited in this respect. For example, in examples described below, one or more types of employment information processed by an attrition prediction system may be derived from monitoring employees' use of software tools in an enterprise network. The software tools may include productivity tools provided by the employer to the employees for the day-to-day performance of the employee's job duties, as well as for interactions with coworkers and other collaborators. The software tools may additionally or alternatively include software tools specifically directed toward employee training and management. The software tools or another system implemented by the employer may track employees' use of the tools, including by evaluating the employee's use of computers on which the software tools are executing, the data created and/or stored by employees while using the software tools, and/or electronic communications transmitted over one or more computer networks by employees while using the software tools. Attrition prediction systems may then, in some embodiments, determine a likelihood of an employee voluntarily ending employment based at least in part on numeric values derived from information on employee's use of the software tools.

Various features of some systems for determining a likelihood of employment of an employee ending have been described. It should be appreciated, however, that embodiments are not limited to implementing any particular features or combination of features described herein. Rather, embodiments can be implemented in any of numerous ways, and are not limited to any particular implementation techniques. Thus, while examples of specific implementation techniques are described below, it should be appreciate that the examples are provided merely for purposes of illustration, and that other implementations are possible.

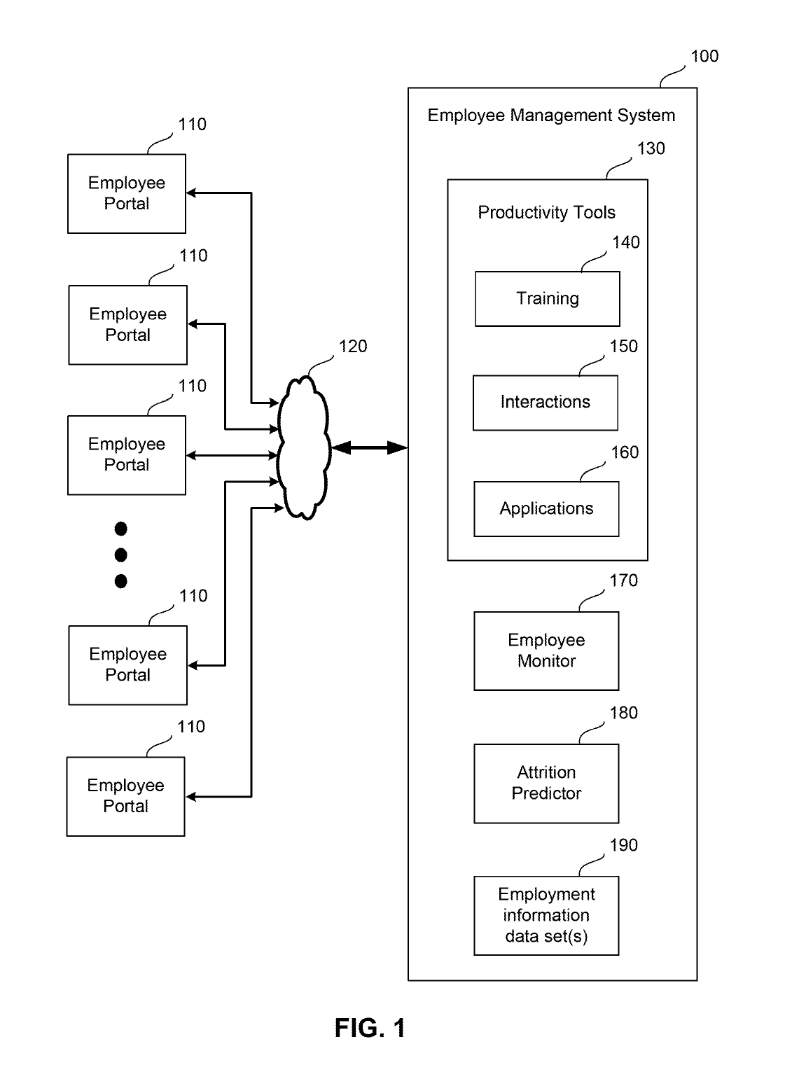

One illustrative application for the techniques described herein is for use in a system for predicting employee attrition. An exemplary operating environment for such a system is illustrated in FIG. 1. The exemplary operating environment includes an employee management system 100, which may be implemented in any suitable form, as aspects of the present invention are not limited in this respect. For example, system 100 may be implemented as a single stand-alone machine, or may be implemented by multiple distributed machines that share processing tasks in any suitable manner. System 100 may be implemented as one or more computers; an example of a suitable computer is described below. In some embodiments, system 100 may include one or more tangible, non-transitory computer-readable storage devices storing processor-executable instructions, and one or more processors that execute the processor-executable instructions to perform the functions described herein. The storage devices may be implemented as computer-readable storage media encoded with the processor-executable instructions; examples of suitable computer-readable storage media are discussed below.

As depicted in FIG. 1, system 100 includes productivity tools 130, employee monitor 170, attrition predictor 180, and one or more data sets 190 of employment information for one or more employees. Each of these processing components of system 100 may be implemented in software, hardware, or a combination of software and hardware. Components implemented in software may comprise sets of processor-executable instructions that may be executed by the one or more processors of system 100 to perform the functionality described herein. Each of productivity tools 130, employee monitor 170, attrition predictor 180, and employment information data sets 190 may be implemented as a separate component of system 100 (e.g., implemented by hardware and/or software code that is independent and performs dedicated functions of the component), or any combination of these components may be integrated into a single component or a set of distributed components (e.g., hardware and/or software code that performs two or more of the functions described herein may be integrated, the performance of shared code may be distributed among two or more hardware modules, etc.). In addition, any one of productivity tools 130, employee monitor 170, and attrition predictor 180 may be implemented as a set of multiple software and/or hardware components. Although the example operating environment of FIG. 1 depicts productivity tools 130, employee monitor 170, attrition predictor 180, and employment information data sets 190 implemented together on system 100, this is only an example. In other examples, any or all of the components may be implemented on one or more separate machines, or parts of any or all of the components may be implemented across multiple machines in a distributed fashion and/or in various combinations. For example, the employment information data set(s) 190 may be implemented on one or more computing devices, including in part on a computing device executing the employee management system 100 and in part on one or more other computing devices accessible by the device that executes the system 100. The other computing device(s) may be accessible, for example, via one or more computer communication networks, including the Internet. It should be understood that any such component depicted in FIG. 1 is not limited to any particular software and/or hardware implementation and/or configuration.

In some embodiments, employee management system 100 may be accessible by one or more employees via one or more employee portals 110. Employee portals 110 may be implemented in any suitable manner, including as one or more computing devices and/or terminals, which may be local to and/or remote from employee management system 100, as aspects of the present invention are not limited in this respect. Employee portals 110 may be connected to and may communicate with employee management system 100 via any suitable connection, including wired and/or wireless connections. In the example depicted in FIG. 1, employee portals 110 transmit data to and receive data from employee management system 100 through network 120. Network 120 may be any suitable network or combination of networks, including local and/or wide area networks. For example, network 120 may be a private network, such as an enterprise network accessible to members (e.g., employees) of the employer organization, or a public network such as the Internet, or a combination of both types of networks.

In some embodiments, employees may use employee portals 110 to access productivity tools 130 provided by employee management system 100, and employee management system 100 may in turn collect data regarding the employees' use of these tools. Productivity tools 130 may include any suitable tools provided for the employees' use in conducting their business and performing their responsibilities within the employer organization. In the example of FIG. 1, productivity tools 130 include training 140, interactions 150, and applications 160. Training 140 may implement training tools offered and/or required by the employer for the employees to make use of in expanding and/or reinforcing their skill sets. These may include, for example, online and/or paper-based training courses, seminars and/or webinars, tests and examinations, reference materials, and/or any other suitable training tools. Interactions 150 may implement interaction tools provided to enable collaboration between coworkers and/or other collaborators for the completion of work and the sharing of ideas. These may include, for example, e-mail, calendaring and appointment, notes and tasks lists, address and/or contacts lists, conference booking, web and/or phone conferencing tools, social networking tools, blogs, and/or any other suitable interaction tools. Applications 160 may implement other software applications used by employees in the performance of their responsibilities. These may include, for example, word processing tools, database and spreadsheet tools, graphics design, software development, and/or any of numerous other examples of software applications that may be useful to employees of a particular organization in performing their job duties.

In some embodiments, employee monitor 170 may monitor each employee's use of productivity tools 130 to gather information that may be useful in predicting attrition. The information gathered by the employee monitor 170 may be stored in the employment information data set(s) 190 in any suitable manner. For example, in some embodiments, the information gathered by the employee monitor 170 may be combined with other employment information in the employer's files (e.g., resumes, education, positions held, compensation levels, etc.) to create a dynamically updating profile for each employee. The employment information for each employee stored in the data set(s) 190 may include any suitable information regarding an employee's past, present, or future potential employment, examples of which are discussed in greater detail below.

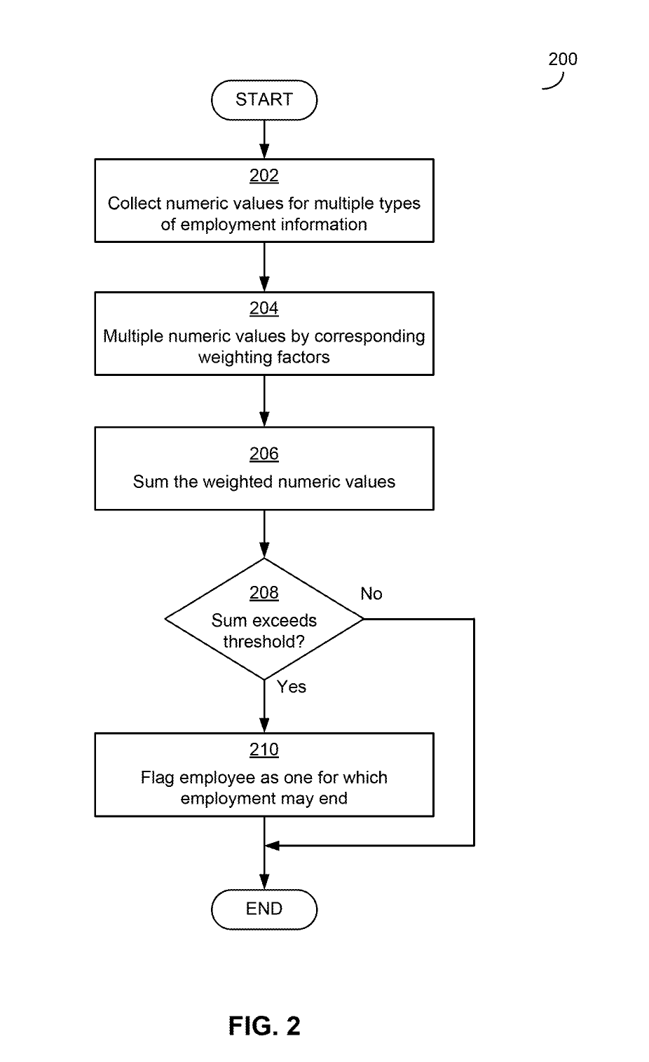

Attrition predictor 180 may perform one or more calculations to generate a numeric value indicating a likelihood of an employee's attrition and may output, based on an evaluation of the numeric value, a prediction of the employee's attrition. Examples of ways in which the attrition predictor 180 may produce the quantitative likelihood and/or the prediction are described below in connection with FIG. 2. The attrition predictor 180, upon generating the quantitative likelihood and/or the prediction, may output the quantitative likelihood and/or the prediction in any suitable manner. In some embodiments, the attrition predictor 180 may store the quantitative likelihood and/or the prediction in a data store, from which they may be subsequently obtained for presentation to a user, who may be a supervisor, member of an HR department, or other person working for an employer. The attrition predictor 180 may also, in some embodiments, present the quantitative likelihood and/or prediction to a user, such as by outputting the values for display in a graphical user interface.

Embodiments that include the employee management system 100 of FIG. 1 are not limited to implementing an attrition predictor 180 in any particular manner. More particularly, embodiments are not limited to performing any particular calculation(s) to generate a numeric value indicating a likelihood that employment of an employee will end. FIG. 2 illustrates an example of a process that may be implemented by an attrition predictor in some embodiments. It should be appreciated, however, that embodiments are not limited to implementing the process 200 of FIG. 2, or any other process.

Prior to the start of the process 200 of FIG. 2, employment information for one or more employees is stored in one or more data stores that are accessible to the attrition predictor. As discussed below, the employment information may be stored in the data stores in any suitable manner. In some cases, the employment information stored in the data stores may include employment information derived by an employee monitoring tool based on information collected through electronically monitoring employees' use of one or more software tools. In other cases, the employment information regarding an employee may have been input by the employee, by the employee's supervisor or peers, or by a member of an HR department. In still other cases, the employment information may have been electronically retrieved from one or more remote data stores, such as data stores operated by others external to the employer and from which employment information is available via the Internet.

Additionally, prior to the start of the process 200, the attrition predictor is triggered to calculate a likelihood of attrition for one or more employees. The trigger to calculate the likelihood of attrition may be, in some embodiments, a request to calculate the likelihood that is received from a user via a user interface of the attrition predictor. In other embodiments, the trigger may be a start of execution of the attrition predictor. In embodiments in which the attrition predictor begins determining a likelihood of attrition following a start of execution, the attrition predictor may be a system that calculates a likelihood of attrition for all employees when the attrition predictor is started. In other embodiments in which the attrition predictor begins determining a likelihood of attrition following a start of execution, the attrition predictor may be a software component that is designed to run continuously over a lengthy period of time and continuously or periodically calculate a likelihood of attrition for one or more employees. In still other embodiments, the trigger that causes the attrition predictor to begin calculating a likelihood of attrition for one or more employees may be a satisfaction of one or more criteria relating to attrition prediction. For example, in some such embodiments, the attrition predictor may monitor for new employment information or for a notification that new employment information is available, and calculate likelihoods of attrition when new employment information is available. As a particular example, when the attrition predictor receives a notification that annual performance reviews have been compiled for employees and are available, the attrition predictor may calculate likelihoods of attrition for one or more employees. It should be appreciated, however, that embodiments are not limited to carrying out the process 200 of FIG. 2 in response to any particular trigger.

The process 200 begins in block 202, in which the attrition predictor collects numeric values for multiple types of employment information that all relate to an employee. The attrition predictor may collect the numeric values in any suitable manner, as embodiments are not limited in this respect. In some embodiments, the attrition predictor may retrieve the numeric values from one or more data stores by communicating with the data stores (and/or with one or more computing devices managing the data stores) via one or more computer communication networks. In some embodiments, the attrition predictor may additionally or alternatively calculate the numeric values based on one or more types of employment information retrieved from one or more data stores by communicating via one or more computer communication networks. In embodiments in which the attrition predictor calculates one or more numeric values corresponding to one or more types of employment information, the attrition may calculate the numeric values in any suitable manner, as embodiments are not limited in this respect. Examples of manners in which an attrition predictor may calculate numeric values corresponding to one or more types of employment information are discussed in detail below.

In block 204, once the attrition predictor has collected numeric values for multiple types of employment information, the attrition predictor multiplies one or more of the numeric values, or all of the numeric values, by corresponding weighting factors. Each weighting factor may correspond to a type of employment information that the attrition predictor may evaluate. The weighting factors may each be a fractional value and may sum to 1. The weighting factors may therefore indicate a strength of a corresponding type of employment information in predicting attrition of an employee and thereby influence an amount by which the corresponding type of employment information affects a total likelihood of attrition of an employee. Further, by weighting the numeric values by a weighting factor that is between 0 and 1 and that together sum to 1, the attrition predictor can generate values that, when summed, yield a value between 0 and 1.

Accordingly, the attrition predictor then, in block 206, sums the weighted numeric values calculated in block 204 to produce a weighted sum that has been derived from the numeric values collected in block 202. The weighted sum calculated in block 206 is a value between 0 and 1 and indicates, as a percentage, a likelihood of attrition for the employee to which the employment information relates.

After the likelihood of attrition for the employee has been calculated as the sum of the weighted numeric values, the attrition predictor compares the likelihood, in block 208, to a threshold. The threshold may be set to any suitable value to indicate that, when a likelihood of attrition is above the value, that the employee is an attrition risk and that it may be desirable to take one or more actions to prevent attrition of the employee. For example, a developer of the attrition predictor and/or an employer may determine that, when a likelihood of an employee ending the employment is above 80%, the employer should take steps to prevent attrition of the employee. Another employer may, however, determine that when the likelihood of an employee ending the employment is above 90%, the employer should take steps to prevent attrition of the employee. Any suitable threshold may be used.

In some embodiments, the threshold that is used may vary between employees, between jobs, between departments, or based on any suitable criteria. Accordingly, in some embodiments, in block 208 the attrition predictor may select a threshold to which the weighted sum is to be compared.

In block 210, in response to determining that the likelihood of the employee's attrition exceeds the threshold, the attrition predictor may flag the employee as one for which employment may end. The attrition predictor may flag the employee in any suitable manner, including by outputting a message indicating that the attrition predictor has predicted that the employee will end employment. The message may be output in any suitable manner, such as being output to a data store of information regarding employees or to a user via a user interface.

Through comparing the likelihood to the threshold and outputting a result of the comparing, the attrition predictor outputs a prediction of whether an employee is a risk for attrition. A prediction produced by the attrition predictor may therefore be an indication of a result of a comparison between a determined likelihood of attrition and one or more thresholds.

Once the attrition predictor flags the employee in block 210, or determines in block 208 that the likelihood does not exceed the threshold, then the process 200 ends.

Following the process 200, an employee management system may store and/or have access to information indicating that the attrition predictor has concluded that the employee is a risk for attrition. As a result of the attrition predictor flagging an employee as a risk for attrition, the employer may take one or more actions to prevent attrition of the employee. For example, an employer (acting through a supervisor, a member of an HR department, or any other person) may provide additional training to the employee, ensure the employee receives increased attention from a supervisor or other mentor, provide suggestions for new collaborations, encourage the employee to participate in activities directed at increasing engagement and/or motivation, and/or any take any other suitable action.

It should be appreciated that, as discussed above, embodiments are not limited to operating the process 200, as the process 200 is merely an example. Other processes are possible, including processes that are variations of the process 200.

For example, while the process 200 included calculating a likelihood of attrition as a percentage that, when closer to 1.0, indicates a higher risk of attrition, embodiments are not so limited. In some other embodiments, an attrition predictor may perform a similar process that produces a likelihood of attrition that, when closer to 0, indicates that the employee is a risk for attrition. In some of these other embodiments, rather than determining whether a likelihood exceeds a threshold, the attrition predictor may determine whether the likelihood is below a threshold. To determine a likelihood of attrition according to a scale that indicates a higher risk of attrition when a likelihood is closer to 0, the attrition predictor may perform the calculation using numeric values and/or weighting factors on one or more scales that trend toward 0 when attrition is likely. Alternatively, the attrition predictor may subtract weighted numeric values from 1.0 rather than summing the weighted factors as described above. In each of the examples described below, the attrition predictor is described as calculating a likelihood that, when closer to 1.0, indicates a higher risk of attrition. Those skilled in the art will appreciate how to modify each of the examples to produce a system that calculates a likelihood according to a different scale.

As another example of a manner in which the attrition predictor may vary between embodiments, embodiments are not limited to comparing a determined likelihood of attrition to a single threshold in determining whether the determined likelihood exceeds or does not exceed the threshold. In some embodiments, the attrition predictor may compare the determined likelihood of attrition to multiple thresholds. For example, the attrition predictor may use two thresholds to determine whether an employee is a low risk of attrition, a medium risk of attrition, or a high risk of attrition. In this example, using two thresholds, the attrition predictor may determine that, when the determined likelihood of attrition exceeds the second, higher threshold, the employee is a high risk for attrition, that when the determined likelihood of attrition is between the thresholds, the employee is a medium risk for attrition, and when the determined likelihood is below threshold, the employee is a low risk for attrition. Other embodiments may use multiple thresholds in any suitable manner. Embodiments are not limited to comparing a determined likelihood of attrition to any particular threshold or to performing any particular operation involving a determined likelihood of attrition.

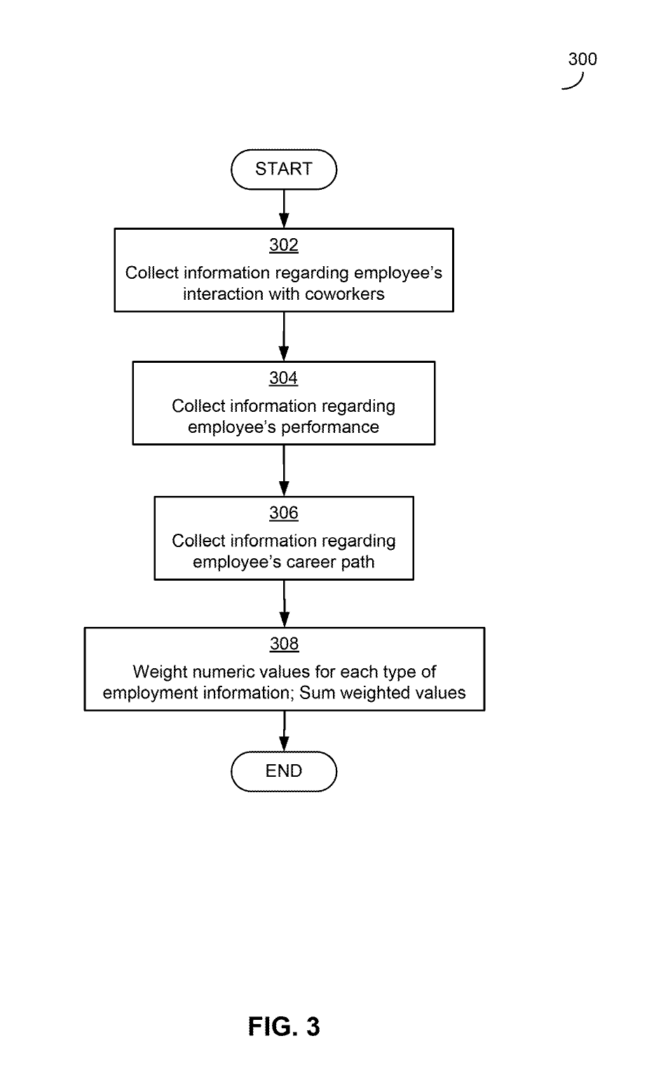

As discussed above, embodiments are not limited to operating with any particular type of employment information for employee. FIG. 3 illustrates an example of a process 300 that may be used in some embodiments by an attrition predictor to collect different types of employment information for employee. It should be appreciated, however, that embodiments are not limited to implementing the process 300 or any similar process.

As with the process 200 of FIG. 2, prior to the start of the process 300 various types of employment information may be stored in one or more data stores accessible to a computing device executing the attrition predictor. The employment information stored in the data stores may have been stored in the data stores in any suitable manner, including according to examples described above in connection with FIG. 2. Further, execution of the process 300 may have been triggered in any suitable manner, including any of the examples of triggers discussed above in connection with FIG. 2.

The process 300 begins in block 302, in which one or more numeric values for one or more types of employment information related to an employee are collected by the attrition predictor. In block 302, the one or more types of employment information that are collected are interaction information for the employee, which characterize interactions between an employee and coworkers of the employee. Interaction information for employee may be created in any suitable manner by any suitable entity. In some examples, the interaction information regarding an employee may be generated by an employee monitor, such as the employee monitor described above in connection with FIG. 1. As discussed above, an employee monitor may be a software tool that monitors an employee's use of one or more software tools that an employer makes available to employees and generates interaction information based on the monitoring. The productivity tools for which employees use is monitored may be computer-based software tools, such as tools that enable or assist an employee in performing his or her job and/or tools that enable communication among coworkers. As discussed above, the employee monitor may monitor an employee's use of one or more computing devices that execute such software tools and/or may monitor electronic communications transmitted and/or received by the software tools in response to instructions from the employee.

Embodiments may operate with any suitable software tools, as embodiments are not limited in this respect. In some embodiments, software tools may include conferencing tools that enable employees to schedule, coordinate, and/or attend conferences, such as web conferences, teleconferences, and seminars or webinars. In some embodiments, software tools may additionally or alternatively include tools to enable communication and collaboration for an employee, such as tools for e-mail, calendaring and appointment, notes and tasks lists, and address and/or contacts lists. Software tools may additionally or alternatively include, in some embodiments, project management tools include notes and tasks tools and documentation tools. The software tools may also, in some embodiments, include software tools that enable employees to carry out their job responsibilities, which may include tools for word processing, database and/or spreadsheet creation and editing, graphics design, software development, or any other tools that an employee may use within the scope of their employment. In embodiments in which the use of these software tools is monitored and used in the prediction of attrition, an employee's use of the tools may be used to calculate a numeric value indicative of the amount of the employee's use of the tools. If an employee is using these software tools very little, it may be indicative that an employee is shirking responsibilities or is otherwise not fully engaged with his or her employment, which may be indicative of an attrition risk. On the other hand, if the employee is using the software tools in a manner similar to or more than his or her coworkers, the employee may be determined to be engaged with employment or otherwise not a risk for attrition.

Thus, in some embodiments, an average amount of use of these software tools (which be the tools individually or as a group) by employees of the employer, employees in a department, or employees in a particular job may be tracked by the employee monitor. The use may be monitored as a number, length, or frequency of interactions, or any other suitable measure of use. To determine a risk of attrition for a particular employee, the employee's use of the software tools may be compared to the average use for all other employees of the employer, other employees in the same department as the employee, or other employees in the same job as the employee. A numeric value indicative of the employee's relative use of the software tools may then be calculated in any suitable manner, such as based on the mean and standard deviation in other employees' use and the employee's use. For example, a number of e-mails sent and/or received by the employee, the length of the employee's e-mails, the frequency of e-mails, the frequency with which the employee's mailbox capacity is reached, the number of meetings the employee has attended, the length of the meetings the employee has attended, the number of posts the employee makes to each web conference, the number of connections in the employee's social network and/or contacts in the employee's address book, etc. may be compared to information for other employees' use. A value indicative the number of standard deviations between the employee's use and an average for other employees' use may be calculated, for example. As another example, a ratio of the employee's use to other employees' use may be calculated.

Additionally or alternatively, a numeric value may be calculated for use of software tools based on a timing of the employee's use, such as a timing of the employee's response to a use by another employee. This may be the case when, for example, another employee's use of a software tool solicits a response from an employee. The employee may be requested to respond, for example, when another employee schedules a meeting and the employee is requested to confirm attendance, or when another employee sends an e-mail message to the employee and the employee is requested to respond. In embodiments in which other employees' use of the software tools solicits a response from the employee, an attrition prediction may be made based at least in part on a timing of the employee's response. For example, an acceptable length of time for an employee to respond, during business hours, may be set and an employee's response times may be measured against that acceptable length of time. For example, if the system specifies that employees typically respond to messages within a four hour window, and the employee typically responds to messages much later, such as several days later, this may be a sign that the employee is not engaged with employment or is otherwise a risk for attrition. Accordingly, in some embodiments, a numeric value indicative of the employee's response time relative to response times for other employees may be calculated and used in determining a likelihood of attrition of the employee.

Some employers may also provide social networking tools to their employees to assist employees in collaborating with their coworkers and communicating with their coworkers. Such social networks may be computer-based, such that employees access the social networks via a computing device and use the social networks to create electronic messages. Such social networks may be social networks specific to the employer, internal to the employer's computer network and not accessible by people who are not employees. In some embodiments, an employee's participation in such a social network may be monitored and a numeric value indicative of such participation may be generated and used in predicting attrition of the employee. U.S. patent application Ser. No. 13/371,451, filed on Feb. 12, 2012, and titled “Methods and apparatus for evaluating members of a professional community,” (the disclosure of which is incorporated by reference herein in its entirety and at least for its discussion of calculating an influence score) describes a technique for calculating a “pQ” score. The pQ score is a numeric value indicative of an influence of an employee in a social network, which may be indicative of an employee's influence with other employees of the employer. In some embodiments, an employee management system of an employer may include a social network tool and a tool for calculating a pQ score indicative of an employee's influence in a network. In these embodiments, the pQ score may be used by an attrition predictor as part of predicting an attrition of an employee. This may be because when the employee is more influential in an employer's social network, the employee may be more engaged with employment and may be a lower attrition risk. Thus, when an employee has a higher pQ score, the employee may have a lower risk of attrition. In systems that include a software tool that monitors an employee's influence in an organization based on social networking posts, the attrition predictor may obtain information on the employee's influence from the software tool. For example, the attrition predictor may communicate with the software tool to retrieve the information and/or retrieve the information from data stores maintained by the software tool.

While examples of numeric values related to types of interaction information for an employee have been described, it should be appreciated that embodiments are not limited to evaluating any particular type of interaction information. Embodiments that implement the process 300 of FIG. 3 may collect numeric values related to any suitable type of interaction information, and the numeric values may be calculated in any suitable manner.

In addition to collecting numeric values related to interaction information, in block 304, the attrition predictor may collect numeric values regarding performance information for an employee. Performance information for an employee may include information related to an employee's qualifications for employment, which may be indicative of the employee's capability to perform his or her employment. Performance information for an employee may additionally or alternatively include performance ratings submitted by an employee's supervisor and/or coworkers.

In embodiments in which performance information related to an employee's capability to perform is used to determine attrition risk, a numeric value for capabilities may be calculated in any suitable manner. For example, in some embodiments, a profile for an employee's job may include a listing of necessary skills and a corresponding listing of proficiency levels for those skills that are required for the job. The skills may include any suitable skills that may be required of an employee for a job. For example, for a software developer, a skill may relate to the ability to develop software in a particular programming language. As another example, for a salesperson, a list of skills may include a list of products that the employee is responsible for selling and with which the employee is expected to be familiar. As another example, employees may be required to be familiar with certain technology, such as software applications, that they may use to carry out their responsibilities, such as Word processing applications. When an employee does not have the required proficiency level for a particular skill, such as when a list of products that a salesperson is to vend or when technology employees are to use changes, an employee may struggle with their work and be a higher risk for attrition.

A numeric value indicative of an employee's capability of performance may be determined by comparing an employee's proficiency levels to the proficiency levels required for their job. A profile for an employee, such as an employee profile maintained in an HR data store for the employee, may include a listing of the employee's proficiency levels, which may be set by the employee, a supervisor, and/or HR for each skill that the employer requires of the employee. A numeric value may be calculated in any suitable manner, as embodiments are not limited in this respect. In some embodiments, a calculation involving each skill may be performed, where a ratio of employee's proficiency level to required proficiency level is calculated for the skill. For example, where an employee's performance level is a “5” out of a 6-level proficiency rating, and the required proficiency level is a “4” out of that 6-level rating, a calculation of 5/4=1.25 is performed for the skill Once the calculation is performed for each skill required for the job, an average may be taken out of each of the values produced. The average may be a straight average, accounting for each of the skills equally, or may be a weighted average taken by weighting some skills (which an employer may have indicated are more important skills for the job) more than others. In the case where an employee meets, but does not exceed, all of the required proficiency levels, the numeric value indicative of the capability of performance would be 1.0. In the case that an employee does not meet any of the required proficiency levels, the value would be below 1.0, and would be above 1.0 in the case that an employee exceeds all of the required proficiency levels. For employees who have met some required skills and not others, the numeric value may be above or below 1.0. It should be appreciated, however, that embodiments are not limited to calculating a numeric value in any particular manner.

Performance information relating to a capability of performance may additionally or alternatively include information related to training that an employee is expected to receive to be capable of performing in his or her job. For example, an employer may specify that an employee is required to obtain certain licenses and/or certifications to hold his or her job, and an attrition prediction may be based at least in part on whether the employee obtains these licenses/certifications. A numeric value indicative of whether an employee has received the necessary licenses and certifications may be calculated in some embodiments. The numeric value may be calculated by assigning a value of 1.0 to each required license/certification that the employee has received and a value of 0.0 to each required license/certification that the employee has not received. In the case that an employer sets a minimum threshold on mastery of the material, such as a minimum grade received as a result of the training, the numeric value may be assigned based in part on whether the employee has met or surpassed this minimum mastery threshold. For example, if an employee was required to obtain a B or greater in a training program, and the employee received a C, the employee may be given a lower score (e.g., a 0.5) or a 0.0 to account for this lower grade. Once the numeric values are assigned to each license/certification, an average (either a straight average or a weighted average) of those values may be calculated. The average may indicate the number of required licenses/certifications that the employee has obtained out of the total number of required licenses/certifications. The numeric value may be indicative of willingness/motivation to obtain licenses/certifications. When the value is closer to 1.0, the employee may be a lower risk for attrition.

Additionally or alternatively, a numeric value may be calculated that is indicative of a willingness of the employee to obtain the licenses/certifications or a motivation of the employee to obtain the licenses/certifications. For example, some employers may set deadlines for employees to obtain the licenses/certifications, such as within six months of starting the job or within one month of the license/certification program being introduced. In the case that an employee is given a deadline by which to obtain the license/certification, a numeric value may be calculated that is indicative of whether the employee obtained the licenses/certifications early, on time, or late. For example, a numeric value may be assigned to obtaining a license/certification more than a month, or more than two weeks, or any other suitable amount of time, before a deadline. The value may be a value that, when combined in a calculation with other values, indicates a greater willingness of the employee to obtain the license/certification, because the value may increase a result of the calculation. This value may be, for example, 1.5. A numeric value may also be assigned to obtaining a license/certification within the two weeks before a deadline, such as 1.0, and a numeric value may be assigned to obtaining a license/certification after the deadline, such as 0.5. These values, or any other suitable numeric values, may indicate an acceptable willingness and an unacceptable willingness, respectively, to obtain the licenses/certifications, when combined with other values in a calculation, as these values may cause a result to stay the same or decrease. In the case that an employee is in the process of obtaining a license/certification at the time an attrition prediction is being produced, a numeric value may be assigned based on a length of time expected to complete the program and obtain the license/certification and a length of time remaining before the deadline. Once a numeric value is calculated for each license/certification, an average value (e.g., a straight average or a weighted average) may be calculated that is indicative of a willingness/motivation of the employee to obtain the required licenses/certifications. When the value is close to or exceeds 1.0, the employee may be less of a risk for attrition.

In some embodiments that evaluate licenses and certifications to determine whether an employee is a risk for attrition, an attrition predictor may obtain information regarding the completion of a program and/or progress toward completion of the program and obtaining a license/certification from any suitable source. In some embodiments, the information may be entered manually, such as when an employee or a member of an HR department inputs information regarding license/certification programs in which the employee is enrolled or that the employee completed. In other embodiments, however, an employee management system implemented by an employer may include a software tool to provide training to employees. Through such a software tool, an employee may receive instructional material regarding a training, such as videos and/or documentation, and may complete testing regarding the training. The training tool may provide employees opportunities to earn licenses and/or certifications as a result of the training. In the case that an employer provides such a training tool, the software tool may monitor an employee's interaction with the training tool, or an employee monitor (such as the employee monitor discussed above in connection with FIG. 1) may monitor an employee's interaction with the training tool. From the information regarding the employee's interaction with the training tool, including information input by the employee to one or more computing devices and/or information output to the employee by one or more computing devices, information on an employee's willingness/motivation to obtain licenses/certifications may be derived and used as discussed above. In systems that include a software tool to provide training to employees, the attrition predictor may obtain information on licenses/certifications obtained by employees from the software tool. For example, the attrition predictor may communicate with the software tool to retrieve the information and/or retrieve the information from data stores maintained by the software tool.

As mentioned above, performance information that may be collected in block 302 may include performance ratings for an employee. Such performance ratings may have been assigned by a supervisor and/or by an employee's peers, or by any other suitable party responsible for providing ratings of an employee. The ratings may be generated based on periodic reviews completed for employees, such as based on annual reviews, quarterly reviews, or reviews at any other suitable interval. A numeric score may be calculated based on periodic reviews in any suitable manner. For example, some performance reviews implemented by employers result in a grade for an employee, such as a rating on a scale of 1 to 5 or a rating on a scale of 0 to 100. In cases in which an employee's review includes a score, the score can be converted to a decimal between 0 and 1 that is proportional to the rating and taken as the numeric value indicative of an employee's performance.

As another example, some performance reviews include a listing of goals that were set for the employee during the review period and an identification of which of those goals were met by the employee. Such performance reviews may additionally include an indication of rewards that were given to an employee for performance, such as rewards corresponding to an employee's achievements during the review period. The goals and awards may be used in determining a numeric value for the employee's performance during the review period. For example, a numeric value may be calculated based on a ratio of goals indicated as met versus total goals. In this case, if the employee had five goals and the review information indicates that the employee met four of those goals, the employee may receive an 80% for the review period. In some cases, the goals may not be weighted evenly, and a number between 0 and 1 may be calculated based on which goals were met and a weight attached to those goals. Additionally, in the case that an employee earns rewards, those rewards may be added on to a numeric score. For example, a particular reward may be marked as earning an employee 0.05 extra points in a calculation indicating an employee's performance. As a result, the employee in the example above who received an 80% score would receive an 85% score if that employee received the reward. Each reward may be associated with a point value, and these point values may be used in any suitable manner to calculate a numeric value indicative of employee performance. A numeric score calculated in this manner may be indicative of employee performance and may, when close to or exceeding 1.0, indicate that the employee is a lower risk for attrition.

In some embodiments, performance information related to performance ratings of an employee may be limited to the most recent performance rating of an employee. In other embodiments, however, employee performance information may be considered in the context of prior performance ratings, such as all previous performance ratings for the employee, performance ratings within a certain amount of time (e.g., within the last two years), or a certain number of performance ratings (e.g., the last five performance ratings). The prior performance ratings may be used in any suitable manner to determine a numeric value indicative of performance ratings for an employee. For example, a straight average of the most recent performance ratings and the prior performance ratings may be calculated. As another example, an average weighting performance ratings according to how recent they are may be calculated, such as by calculating an average that is weighted toward the most recent performance rating. Any suitable calculation may be carried out, as embodiments are not limited in this respect.

Performance rating information may be obtained from any suitable source in any suitable manner, as embodiments are not limited in this respect. In some embodiments, performance review information may be stored in a data store, such as a database, and retrieved by an attrition predictor for use as described herein. In other embodiments, however, an employee management system implemented by an employer may include a software tool that provides performance rating functionality. For example, such a tool may provide the ability set goals for employees and indicate whether employees have met the goals, provide ratings of employees on a scale, provide feedback commentary to employees, or otherwise carry out a review of an employee. In systems that include a software tool to assist in performance reviews, the attrition predictor may obtain information on performance ratings of employees from the software tool (and/or with a computing device executing the software tool). For example, the attrition predictor may communicate with the software tool to retrieve the information and/or retrieve the information from data stores maintained by the software tool.

While examples of numeric values related to types of performance information for an employee have been described, it should be appreciated that embodiments are not limited to evaluating any particular type of performance information. Embodiments that implement the process 300 of FIG. 3 may collect numeric values related to any suitable type of performance information, and the numeric values may be calculated in any suitable manner.

In addition to interaction information and performance information, in the embodiment of FIG. 3 the attrition predictor may evaluate career path information for an employee in calculating a likelihood of attrition for the employee. Career path information may include information relating to a career history for the employee and/or potential future career of the employee. Any of multiple types of career path information may be evaluated and numeric values for the types used in determining a likelihood of attrition for an employee.

For example, in some embodiments, information on the potential future career of an employee may include a member of the HR department's subjective belief regarding whether the employee is a risk for attrition. The HR department's subjective belief, which may be termed the HR department's evaluation of the employee's “talent flight risk,” may be input to an electronic data store by a member of the HR department via an suitable interface. The HR department may set the value based on any suitable factors, including based on similarity of an employee to one or more employees for whom employment has recently ended. For example, if another employee for whom employment recently ended worked in the same department or had the same job as the employee, the employee's risk of attrition may be higher. This subjective belief may be in any suitable format, such as a rating on a scale (e.g., a three-point scale such as low, medium, and high) or a numeric value. The subjective belief may be converted to a numeric value for use in attrition prediction. For example, in the case that the subjective belief is formatted as a rating on a scale, the ratings of the scale may correspond to enumerated numeric values. For example, on a low, medium, high scale, the ratings may correspond to numeric values of 10%, 50%, and 100%, or any other suitable values. In the case that the subjective belief is a numeric value, the numeric value may be normalized to be a value between 0 and 1 such that a higher value is indicative of a greater attrition risk. In embodiments in which an HR department's subjective belief is used as part of determining an attrition risk, the subjective belief may be formatted in any suitable manner and a numeric value may be calculated in any suitable manner, as embodiments are not limited in this respect.

As another example of career path information, information on the potential future career of an employee may include information on an employee's efforts to seek out new opportunities at the employer. This “talent potential” rating may be a subjective belief of a member of the HR department that the employee is content with the employment and is seeking out ways to expand or grow his or her role within the company. The talent potential rating that is input by the member of the HR department may be inversely proportional to likelihood of attrition: as the talent potential increases, the likelihood of attrition drops. As with the “talent flight risk” above, the subjective belief input by the member of the HR department may be in any suitable format, including in the form of a rating on a scale or a numeric value, and the subjective belief may be converted to a value between 0 and 1, with a lower value being indicative of a higher attrition risk.

As another example of career path information, information on the current career circumstances and potential future career of an employee may include information on the employee's compensation. For example, information on industry average compensation for a job may be obtained by an employer from one or more data services that provide such information. Such information may be obtained by a computing device implementing an attrition predictor by electronically requesting, via one or more computer communication networks, that a remote computing device transmit compensation information. Employee compensation data may then be obtained, such as from one or more data sets maintained by an HR department. A numeric value indicative of an employee's compensation may then be calculated as a ratio of employee's compensation to industry average. If the resulting numeric value is below 1.0, then the employee is earning less than average, which may be a sign of attrition risk. If the resulting numeric value is above 1.0, however, the employee is earning more than average, and may be less of a risk for attrition. Accordingly, the numeric value regarding compensation may be inversely proportional to attrition risk: as the number decreases, attrition risk increases.

Compensation information may also be evaluated by an attrition predictor in the context of financial successes or disappointments of an employer. For example, the employer may have a bad quarter or year, and financial reports for the employer may indicate that the employer has suffered losses. As a result, publicly-traded stock in the employer may fall in price. In the event that the employee owns shares of stock, or owns stock options, a drop in stock price may affect the employee's compensation or potential compensation. When the employee's compensation is low as a result, the employee may be more likely to end employment than when the financial success of the company is providing financial benefits to the employee. A numeric value indicative of compensation of the employee that is tied to the financial success of the company may be calculated in any suitable manner. In some embodiments, for example, good financial results for the company, such as results that increase a stock price, may increase a numeric value of the employee's compensation, such as by increasing the numeric value by a certain number of extra points, similar to the extra points discussed above in connection with rewards and employee performance. Similarly, disappointing financial results for the company, such as results that decrease a stock price, may decrease a numeric value of the employee's compensation by a certain number of extra points. This may be done, in some embodiments, for all employees based on financial results of the company. In other embodiments, however, the attrition predictor may determine from one or more electronic data stores, such as one or more databases maintained by the HR department, which employees own stock in the company. When the attrition predictor is aware of which employees own stock in the company, the attrition predictor may adjust numeric values indicative of compensation only for those employees who own stock.

As another example of career path information for which numeric values may be collected in block 306, employment history of the employee may be evaluated and used to produce a numeric value that indicates a likelihood of attrition. The numeric value indicative of attrition may be calculated based on any suitable factors that can be determined from an employee's employment history. The employment history that may be evaluated may include both an internal employment history, including history of employment with the employer, and external employment history, including history of employment by others. In some embodiments, lengths of time that an employee typically spends in a particular job may be determined from the employee's employment history. For example, an average amount of time that the employee spends in any particular job may be determined and compared to the length of time that the employee has spent in his or her current job. If the employee is nearing or past an amount of time that is average for the employee to stay in a job, then the employee may be looking for a change in circumstance and may be looking for a new position, in keeping with the employee's trend of moving jobs. Similarly, if the employee's total tenure with the employer (in the current job and previous jobs with the employer) is nearing an average total tenure with prior employers, then the employee may be looking for a new job. In either case, time may be evaluated in determining an employee's likelihood of attrition. For example, once an average time spent in a job is calculated for the employee, a ratio of the time spent by the employee in his or her current job to average time may be calculated. The higher the ratio is, the more likely the employee may be to end employment. Similarly, for total tenure with employers, a ratio of time spent with the employee's current employer to average time spent with an employer may be calculated. The higher this ratio is, the more likely the employee may be to end employment. Information on an employee's employment history and current length of time in a position or with the employer may be obtained from any suitable source. In some cases, for example, the information may be retrieved from one or more electronic data stores, such as one or more databases maintained by an HR department.

Another example of time-related career path information that may be evaluated by an attrition predictor in some embodiments is information related to an average tenure of employees in a particular job. The average tenure may be calculated for employees of the employer in the job and/or for employees in the job or similar jobs in the market. Such information may be obtained from an electronic data store maintained by an HR department and/or from one or more data services that provide such information, such as by communicating with one or more remote computing devices via one or more computer communication networks. Similar to the manner in which time information was used in the foregoing examples, average tenure in a position may be used in calculating a ratio of time the employee has spent in a position to the average time spent by people in the position. When the numeric value of the ratio is higher, the employee may be a higher attrition risk.

As another example, in block 306, the attrition predictor may evaluate potential job opportunities for the employee as part of evaluating potential future career of the employee. The potential job opportunities for the employee may include a set of jobs with the employer that the employee may be considered for. A member of the HR department may input this information as part of managing employees and charting potential growth of employees. When such information is available, a number of positions for which the employee is being considered may be used in predicting a possible attrition of the employee. For example, if the employee is being considered for positions within the company, the employee may be performing well and may be well liked by supervisors, and may be a low risk for attrition. Conversely, an employee who is not being considered for other positions may not be performing well or may not be well liked, and may be a higher risk for attrition. A numeric value based on jobs available within the company may be calculated in any suitable manner, including by assigning a 1.0 when the employee is being considered for positions and a 0.0 when the employee is not being considered for positions. When the value is 1.0 or closer to 1.0, the employee may be a lower risk for attrition.

In addition to or as an alternative to potential job opportunities with the employer, in some embodiments potential job opportunities outside the employer may be considered. For example, a number of available jobs for which an employee is qualified may be evaluated. In the case that many jobs are available to an employee, the employee may be a higher attrition risk than in the case that few jobs are available to the employee.

The number of jobs available to an employee may be monitored in any suitable manner. For example, a member of the HR department may monitor the job market manually and input a value to an electronic data store indicating, for a particular job with the employer, whether there are many other jobs available. Alternatively, a computing device implementing the attrition predictor may communicate with one or more computing devices executing a job posting service to determine a number of jobs that are available and that are similar to a job offered by an employer. Jobs similar to a job offered by the employer may be identified, such as by specifying a job title or job qualifications to the job posting service and requesting a list of matching jobs. For employees in that job, this value indicating that many other jobs are available in the market may be used to determine a likelihood of attrition. In the case that there are many jobs available, such as more than a threshold number of jobs, a numeric value indicating that there are many jobs available may be used, such as by assigning 1.0 as a numeric value. Conversely, if there are not many jobs available, such as fewer than a threshold number of jobs, then a numeric value indicating this, such as 0.0, may be assigned as the numeric value. This is because the availability of alternate jobs in the market may encourage employees to examine other employment opportunities and increase attrition, whereas a lack of alternate jobs may keep an employee in his or her job and lower a risk of attrition. It should be appreciated, however, that embodiments are not limited to evaluating any particular numeric value or values indicative of job opportunities with an employer or in the market, or to calculating numeric values in any particular manner.

As another example, in some embodiments an attrition predictor may evaluate career interests of an employee in determining a likelihood of attrition of the employee. In some embodiments, an employer may collect from an employee information on career interests, such as ambitions of the employee and/or job characteristics desired by the employee. The career interests of the employee may be evaluated to determine a likelihood that the employee's career interests will be met by the employer. For example, a member of the employer's HR department may review the career interests and determine whether jobs fitting the criteria specified by the employee are available through the employer. As another example, the employee's career interests may be compared to the characteristics of the employee's current job. In either case, a value indicative of a comparison may be calculated. For example, if the employee has provided a number of career interests, a numeric value between 0 and 1.0 may be calculated that is proportional to the number of career interests of the employee that are met by the employee's current job or that may be met by the employer. In such a case, if four out of five career interests specified by an employee are met by the employee's current job or may be met by the employer, a value of 80% may be assigned as a numeric value corresponding to the employee's career interests. This numeric value may be inversely proportional to attrition risk in that, as the value increases, the risk of attrition decreases.

While examples of numeric values related to types of career path information for an employee have been described, it should be appreciated that embodiments are not limited to evaluating any particular type of career path information. Embodiments that implement the process 300 of FIG. 3 may in block 306 collect numeric values related to any suitable type of career path information, and the numeric values may be calculated in any suitable manner.

Once the attrition predictor has collected numeric values regarding an employee's interactions, performance, and career path in blocks 302, 304, and 306, respectively, the attrition predictor weights the numeric values for each type of employment information collected in blocks 302-306 and sums the weighted numeric values. The weighting and summing in block 308 may be carried out in any suitable manner, including according to examples described above in connection with FIG. 2.

Once the attrition predictor has calculated the weighted sum, the process 300 ends. The weighted sum may be used as a numeric value indicative of a likelihood that employment of an employee will end and may be used in any suitable manner. For example, the numeric value may be stored and may, in some embodiments, be compared to one or more thresholds as discussed above in connection with FIG. 2.

In some examples discussed above, the manner in which a numeric value indicative of a type of employment information for an employee is calculated produces values that are inversely proportional to risk of attrition. For example, in some examples discussed above, as a numeric value corresponding to a type of employment information grows closer to 1.0, the risk that the employee will end employment may be lower. In such cases, summing these values together with other values that are directly proportional to attrition risk may not produce a number that is indicative of attrition risk, as the values are on different scales. To simply sum weighted numeric values to determine a likelihood of employment ending, the numeric values should be on the same scale, such as that higher values indicate higher risk of attrition or that lower values indicate a higher risk of attrition. In some embodiments, therefore, when a numeric value that is inversely proportional to attrition risk is calculated, that value may be subtracted from 1 to produce a complement of the calculated value. The complement may indicate the same information as the originally-calculated value, but be on a scale on which numeric values are directly proportional to attrition risk. As another example, in some embodiments, a value that is inversely proportional to attrition risk may be made negative prior to weighted numeric values being summed. As a third example, in some embodiments, an attrition predictor may calculate a risk of attrition by summing values that are directly proportional to attrition risk and subtracting values that are inversely proportional to infringement risk. In still other embodiments, numeric values may always be calculated to be directly proportional to infringement risk, and the weighted numeric values may be summed. Any suitable processes may be implemented for calculating numeric values and/or for determining likelihoods of employment ending, as embodiments are not limited in this respect.

While various examples of types of employment information were described above in connection with FIG. 3, it should be appreciated that the foregoing are only examples, and embodiments are not limited to any particular list of information to be monitored for predicting employee attrition. Embodiments may be implemented that do not monitor these types of information and embodiments may be implemented that monitor any combination of one or more of the above types of information, possibly with the addition of one or more other types not listed above. For example, some embodiments may not evaluate one or more of interaction information, performance information, and career path information. In some embodiments, an administrator of the employer, such as one or more members of an HR department, may establish the list of types of information to be monitored in employee attrition prediction. However, embodiments are not limited to selecting the list of types of employment information to evaluate in any suitable manner.

The process 300 of FIG. 3 was described as including steps in which an attrition predictor “collected” numeric values regarding one or more types of employment information. It should be appreciated that embodiments are not limited to obtaining numeric values in any suitable manner. In some embodiments, the numeric values for each type of employment information may be calculated by software components executing on computing devices or other entities separate from the attrition predictor. In other embodiments, however, the attrition predictor may calculate numeric values for one or more types of employment information.

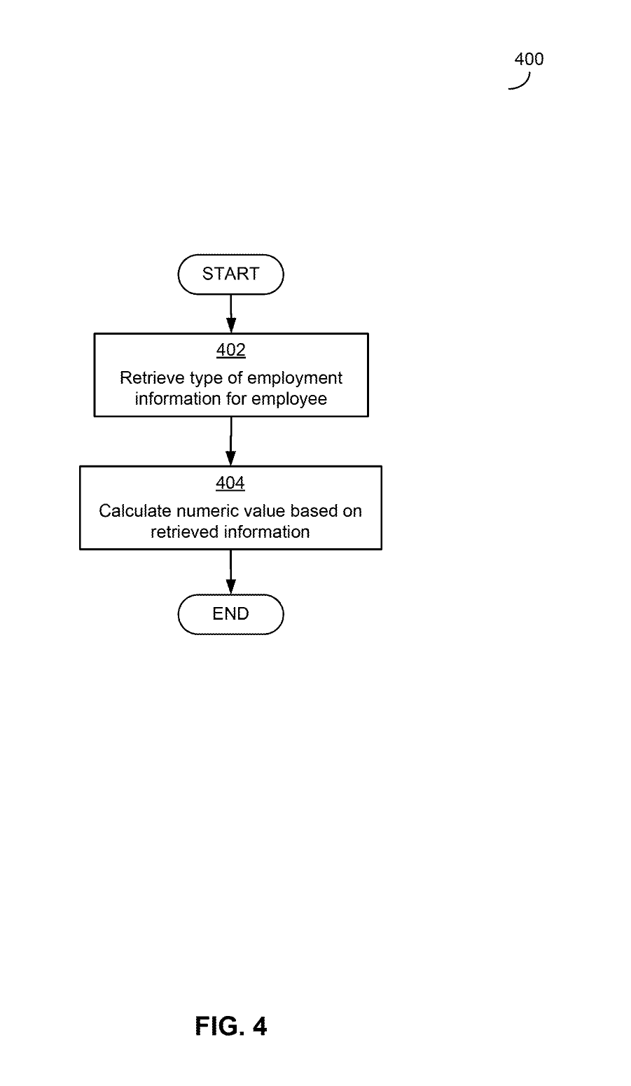

FIG. 4 illustrates an example of a process 400 that may be carried out in some embodiments to determine numeric values for one or more types of employment information. Prior to the start of the process 400, the attrition predictor may have been triggered to begin calculating an attrition prediction for an employee and may have identified the employment information on which the attrition prediction is to be based.

The process 400 begins in block 402, in which the attrition predictor retrieves a type of employment information for an employee from an electronic data store. The employment information may be retrieved from any suitable source, as embodiments are not limited in this respect. In some embodiments, for example, the employment information for the employee may be obtained from a data store maintained by the employer and/or from a data store outside the control of the employer. The information that may be obtained may be in any suitable format, as embodiments are not limited in this respect. Examples of formats of types of employment information are described above in connection with FIG. 3.

In block 404, once the attrition predictor has retrieved the information in block 402, the information may be used to calculate a numeric value. The numeric value may be calculated based on the retrieved information in any suitable manner, as embodiments are not limited in this respect. Examples of ways in which employment information may be used to calculate numeric values are described above in connection with FIG. 3 and any of these exemplary ways, or any other way, may be implemented in embodiments.

Once the attrition predictor has calculated the numeric value in block 404, the process 400 ends. Following the process 400, the numeric value may be used in any suitable manner. For example, the numeric value may be stored in one or more data stores and/or may be weighted according to a weighting factor corresponding to the type of employment information and used in calculating a likelihood that employment of the employee will end.

Some embodiments use weighting factors to weight numeric values indicative of employment information as part of calculating a likelihood that employment of an employee will end. These embodiments are obtain these weighting factors from any suitable source. In some embodiments, an attrition predictor may have these weighting factors hard-coded into the attrition predictor, or the weighting factors may otherwise be set by a developer of the attrition predictor. In other embodiments, however, an employer using the attrition predictor may have the option to set any or all of the weighting factors. The employer may, in some such embodiments, set the values in the first case, such as during an initial configuration following installation. In other embodiments, however, a developer may provide default values for the weighting factors and an employer may be given an option to change the weighting factors at any time.

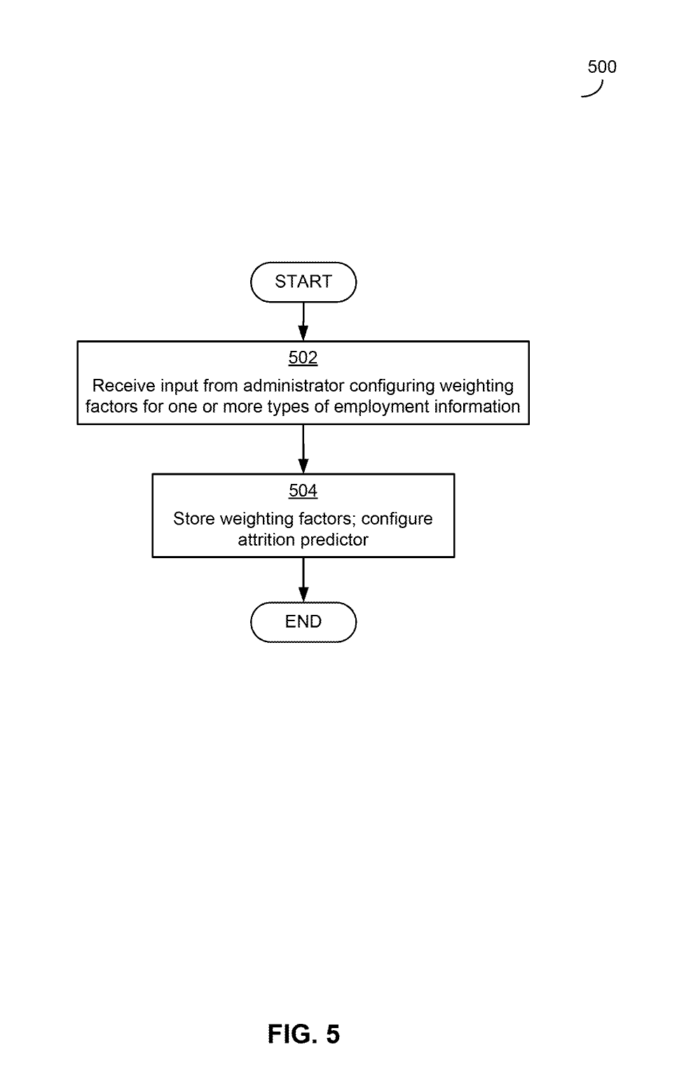

FIG. 5 illustrates an example of a process that may be carried out in some embodiments by an attrition predictor to receive information regarding weighting factors from an administrator. The administrator may be any suitable administrator of an employee management system that includes the attrition predictor. In some embodiments, the administrator may be an employee of an employer, such as a member of an HR department for the employer. It should be appreciated, though, that embodiments are not limited to receiving input from an particular person or entity.

Prior to the start of the process 500, an attrition predictor may be installed on one or more computing devices. The computing devices may be under the control of any suitable entity and may be located at any suitable place. In some embodiments, the computing devices may be owned and operated by an employer, and the attrition predictor may be installed on the computing devices and used to determine a likelihood of attrition for employees of the employer. In other embodiments, however, the attrition predictor may be installed by an entity other than the employer on computing devices owned by, leased by, or otherwise owned in part by the entity other than the employer. Such an entity may be, for example, a human resources service provider that evaluates information on employees to provide information to employers. Embodiments are not limited to implementing an attrition predictor on any particular computing device or in any other particular manner.

The process 500 begins in block 502, in which the attrition predictor receives input from an administrator that is to configure weighting factors for one or more types of employment information. The input that is received in block 502 may correspond to all, some, or one of the types of employment information that may be evaluated by an attrition predictor to determine a likelihood of attrition for an employee. In some embodiments, through providing the input of weighting factors in block 502, an administrator may select which types of employment information are to be evaluated by the attrition predictor to determine a likelihood of attrition for an employee. For example, by setting a weighting factor corresponding to a type of employment information to 0, the administrator may indicate that the corresponding type of employment information should not be evaluated. To receive the input of weighting factors, in some embodiments the attrition predictor may present to the administrator a graphical user interface that includes a listing of types of employment information that may be included in a calculation. The administrator may then select one or more types of employment information to be included or excluded by setting weighting factors accordingly.

Any suitable weighting values may be input by the administrator in block 502, as embodiments are not limited in this respect. In some embodiments, the administrator may be constrained to inputting weighting factors that sum to 1.0, such that a likelihood of attrition calculated based in part on the weighting factors will be a value between 0 and 1.0. The weighting factors input by the administrator may indicate a strength of a correlation between the type of employment information and attrition of the employee. For example, factors that are more strongly linked to attrition of an employee, such as factors that, when high, always or nearly always indicate a high risk of attrition for an employee, will have a higher corresponding weighting factor than types of information that are not strongly linked to attrition. The weighting factors may be set based on any suitable information regarding strength of correlation, including a guess of the administrator, experience of the administrator, and/or rigorous examination of types of employment information by the administrator. Embodiments are not limited to setting the weighting factors in any particular manner.

In block 504, once the attrition predictor has received the input of the one or more weighting factors, the attrition predictor stores the weighting factors in any suitable data store and configures the attrition predictor with the weighting factors. The configuration of block 504 may be carried out in any suitable manner, as embodiments are not limited in this respect. The attrition predictor may be configured in any manner that results in the attrition predictor applying the weighting factors in the calculation of a likelihood of attrition for an employee.

Once the weighting factors are stored and the attrition predictor is configured in block 504, the process 500 ends. As a result of the process 500, the attrition predictor is configured with new weighting factors and may calculate attrition differently than the attrition predictor was previously configured to calculate attrition.

In some embodiments, weighting factors used in weighting types of employment information may be universal for all jobs, departments, and employees evaluated by an attrition predictor, and the types of employment information evaluated may be the same for all jobs, departments, and employees. In other embodiments, however, an administrator may specify different weighting factors and/or different types of employment information to be evaluated by the attrition predictor for different jobs, departments, employees, or any other person or group of people. For example, an attrition predictor may be used in some embodiments to predict attrition for people at a range of jobs with an employer and the employer may be aware, or believe, that different types of employment information are indicative of potential attrition between those jobs. The employer may be aware, or believe, for example, that employees in a supervisory role are less affected by the availability of jobs at other employers than are non-supervisors. An administrator of the attrition predictor may therefore configure the attrition predictor to give more weight to the availability of other jobs when determining a likelihood of attrition for a non-supervisor than for a supervisor. Similarly, an employer may be aware, or believe, that employment history information may not be very informative for employees in “junior” positions, as these employees may not have had enough work experience for an employment history to provide any telling trends. Employees in “senior” positions, however, may have work experience that may provide helpful clues to potential attrition, such as the time periods discussed above. Accordingly, an administrator may configure the attrition predictor to give no weight to employment history when calculating likelihood of attrition for a junior employee, but may give some weight to employment history when calculating a likelihood of attrition for a senior employee. It should be appreciated, however, that the foregoing are merely examples of ways in which weighting factors may be set by an administrator. Embodiments are not limited to setting weighting factors in any particular manner.

Embodiments are not limited to adjusting weighting factors or any other piece of information in response to any particular condition or at any particular time. FIG. 5 illustrated an example of a process that can be used to initialize weighting factors for an attrition predictor, such as following installation of an attrition predictor. In some embodiments, an administrator of an attrition predictor may adjust weighing factors of an attrition predictor after the weighting factors have been used for a time in determining a likelihood of attrition for one or more employees. For example, in the event that an employee ends employment suddenly, as a surprise to the employer, and the attrition predictor did not predict the attrition, the employer (acting through a member of the HR department or other person) may reconfigure the weighting factors used in determining a likelihood of attrition so as to attempt to ensure that future attrition will be predicted and not come as a surprise. As another example, an administrator may adjust weighting factors as part of predicting a potential future attrition risk for one or more employees.

In some embodiments, techniques described herein may be used to predict how an employee's attrition risk may change over the course of a future period (e.g., over the next 4 weeks, 12 weeks, 6 months, etc.). For example, an administrator may hypothesize that certain events will occur (such as organizational financial reports, job opportunities for an employee, skills changes such as new product/technology introductions, etc.) over a time frame of interest, input one or more types of employment information into the attrition predictor corresponding to the hypothetical events, and compute hypothetical attrition risks for an employee for the time frame of interest. In addition to inputting hypotheses for one or more types of employment information, the administrator may input weighting factors that affect how those types of employment information are weighted in determining a risk of attrition. For example, if an administrator is aware that a new employer is opening soon, and the administrator believes that the opportunities available with the new employer will be very attractive to employees of a first employer, the administrator may input hypothetical job profiles in the system (and/or manually set a numeric value corresponding to the availability of job opportunities) and adjust a weighting factor for job profiles such that job profile information is weighted more than previously.

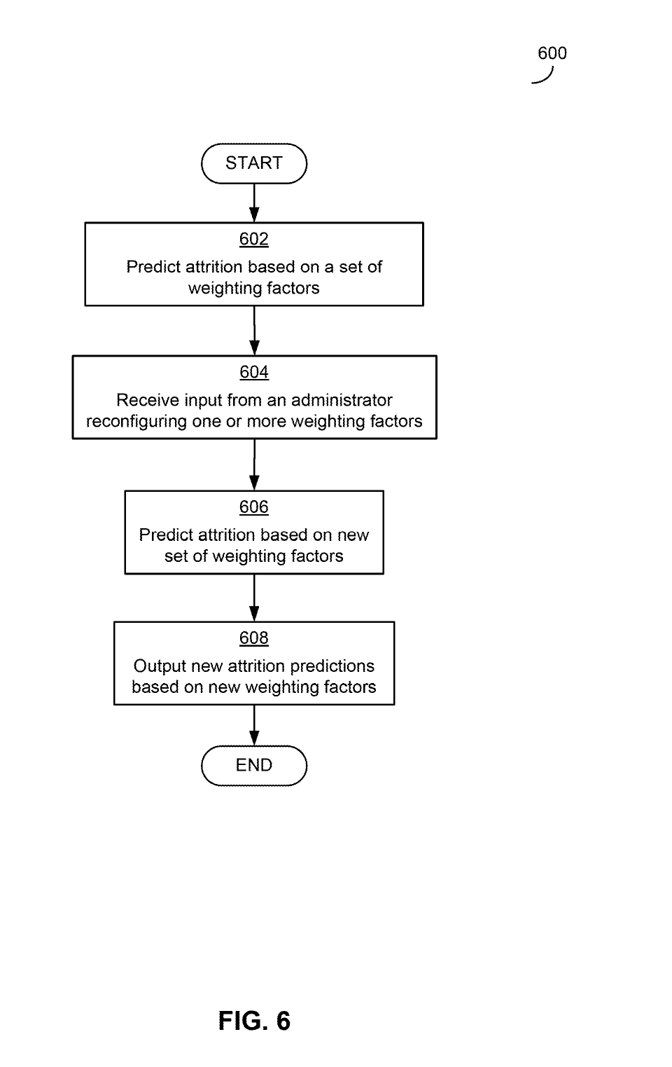

FIG. 6 illustrates an example of a process 600 that may be carried out in some embodiments to configure an attrition predictor with new weighting factors. Prior to the start of process 600, an attrition predictor may be installed on one or more computing devices and used in determining a likelihood of employment of an employee ending. In addition, an administrator may have configured the attrition predictor one or more times with weighting factors to be used in weighting employment information in determining the likelihood. One or more types of employment information for one or more employees may also be stored in one or more data stores, for use in determining the likelihood.

The process 600 begins in block 602, in which the attrition predictor predicts attrition for one or more employees based on a first set of weighting factors. The attrition predictor may predict the attrition in block 602 in any suitable manner, including according to one or more of the examples described above, as embodiments are not limited in this respect.

In block 604, the attrition predictor receives input from an administrator reconfiguring one or more weighting factors with which the attrition predictor is configured. The input may be received from the attrition predictor in any suitable format. In some embodiments, the input from the administrator may specify one weighting factor that is to be changed, or otherwise a set of fewer than all weighting factors of the system.

In some embodiments, all of the weighting factors considered by the system sum to 1.0. When the input from the administrator specifies one or less than all weighting factors, the other weighting factors may be automatically changed by the attrition predictor to produce weighting factors that sum to 1.0. The attrition predictor may automatically change the other weighting factors in any suitable manner, as embodiments are not limited in this respect. In some embodiments, for example, the attrition predictor may adjust these other weighting factors in proportion to their original values relative to one another, such that the ratios between weighting factors remains the same following adjustment. An attrition predictor may not automatically adjust weighting factors in all embodiments, however. In some embodiments, rather, the attrition predictor may receive from the administrator an input of weighting factors for all types of employment information and the input weighting factors may sum to 1.0.

Once the weighting factors are received (and/or adjusted) by the attrition predictor, the attrition predictor may store the weighting factors and configure the attrition predictor to perform calculations using the weighting factors, which may include adjusting one or more other weighting factors. The attrition predictor may be configured to use the weighting factors in any suitable manner, as embodiments are not limited in this respect. Once the attrition predictor is configured with the new weighting factors, in block 606 the attrition predictor predicts attrition of one or more employees by calculating a likelihood of attrition using the weighting factors. In block 608, once the attrition predictor has determined the likelihood that employment of one or more employees will end, the attrition predictor outputs the likelihood(s). The likelihoods may be output in any suitable manner, such as by storing the likelihoods in one or more data stores and/or presenting the likelihoods to a user in a graphical user interface.

Once the attrition predictions are output by the attrition predictor in block 608, the process 600 ends. Following the process 600, the administrator may return the weighting factors to the values that were used for the weighting factors prior to the process 600. In some embodiments, the attrition predictor may store the prior values and provide the administrator with the ability to revert the weighting values without needing to specify the values to the attrition predictor. For example, via a graphical user interface of the attrition predictor, the administrator may provide input instructing the attrition predictor to revert the weighting factors to the prior values.

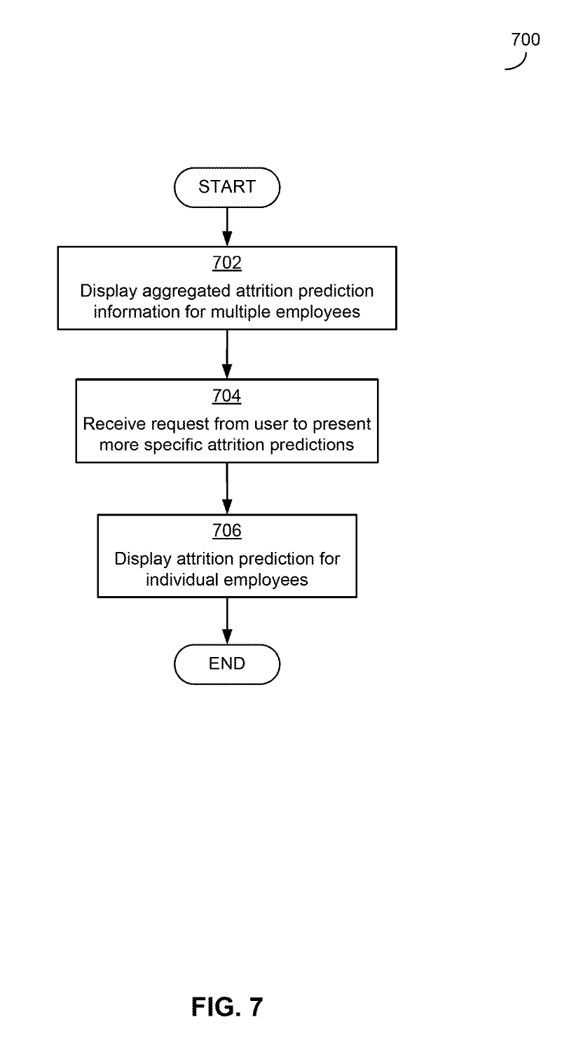

In some embodiments, an attrition predictor provides a graphical user interface by which a user, such as a supervisor, member of an HR department, or other person affiliated with an employer and interested in likelihood of attrition, may view determined likelihoods of attrition for one or more employees. These embodiments are not limited to operating with any particular form of graphical user interface. FIG. 7 illustrates an example of a process that may be carried out by an attrition predictor for outputting determined likelihoods of attrition via a graphical user interface.

Prior to the start of the process 700 of FIG. 7, an attrition predictor is installed and executing on one or more computing devices and has calculated likelihoods of attrition for multiple employees based on employment information for the employees.

The likelihoods of attrition for the multiple employees are stored in a data store accessible by the attrition predictor. The likelihoods may be stored together with an indication of employees to which the likelihoods relate. For example, the likelihoods may be stored with an indication of a job held by an employee, a department in which the employee works, or other characteristic of an employee's employment or the employee, including demographic information for the employee.

The process 700 begins in block 702, in which aggregated attrition predictions for multiple employees are displayed to a user in a graphical user interface. The aggregated prediction information may be any suitable aggregation of predictions. The aggregation may be based on any suitable characteristic of the employee's employment and/or of the employee, as embodiments are not limited in this respect. For example, in some embodiments, the predictions for employees may be aggregated according to jobs held by employees. When aggregating by job, the attrition predictor may determine a total number of employees holding the job and a number of those employees who are detected to be a risk for attrition. The attrition predictor may then calculate a ratio of at-risk employees in the job to total employees in the job and display the ratio in block 702. For example, an employer may have 10 employees in the job “Junior Software Developer” and the attrition predictor may have previously determined that the likelihoods of 3 of those employees ending employment are sufficiently high for the employees to be flagged as risks for attrition. In this example, in block 702, the attrition predictor may output in a graphical user interface “Attrition risk for Junior Software Developer: 30%”, indicating that 30% of the employees in the Junior Software Developer role have been determined to be risks for attrition. as another example of a manner in which the attrition predictor may aggregate, the attrition predictor may aggregate predictions for attrition by department. For example, the attrition predictor may calculate, in a manner similar to the aggregation according to job, that 25% of the sales department is at risk for attrition and output a corresponding message.

When outputting aggregated attrition predictions, in some embodiments, the attrition predictor may display in the graphical user interface context information for the attrition predictions. For example, the attrition predictor may obtain information on an average attrition rate for a job or a department historically for the employer, such as by retrieving such information from one or more data stores maintained by an HR department. As another example, the attrition predictor may obtain information on an average attrition rate for a job or a department in the industry in which the employer operates. The information on average attrition rates in the industry may be obtained from any suitable source, such as from a computing device hosting a data service that provides such information for retrieval via one or more computer communication networks. Outputting context information for aggregated attrition rates may aid a user in understanding the aggregated attrition rates, such as understanding whether the attrition rate is good or bad in the context of the employer's historic attrition or attrition in the industry.

In some cases, a user may be interested in more specific data than is available through the aggregate data displayed in block 702. The user may be interested in learning the particular employees who have been flagged as being at risk for attrition. The graphical user interface may be configured to display such information in response to a request from the user. For example, in response to receiving a request in block 704 to present more specific attrition predictions, the attrition predictor may, in block 706, present attrition information for individual employees. The attrition information displayed in block 706 may include any suitable information calculated for employees based on employment information for the employees. For example, the attrition predictor may display a list of employees who have been flagged as being at risk for attrition and a list of employees who have been flagged as not being at risk. In some cases, the lists may be displayed separately, while in other the lists may be displayed together as a single list of employees. In some embodiments, such as embodiments in which an attrition predictor compares a likelihood of attrition to multiple thresholds, the attrition predictor may output in block 706 a conclusion such as “at risk for attrition,” “not at risk for attrition,” “medium risk for attrition,” or other conclusions that the attrition predictor may make based on a likelihood of attrition calculated for an employee based on employment information for the employee. In other embodiments, however, the attrition predictor may additionally or alternatively output likelihoods determined for employees, such as that an employee has been determined to be “78% at risk for attrition.” The employees for which information is output in block 706 may be any suitable set of employees. For example, the employees may be those employees who have the characteristic by which attrition information was aggregated in block 702. For example, when attrition information for a particular job or department is aggregated, the employees for which information is displayed in block 706 may be those employees who have that job or work in that department.

Once the attrition predictions are displayed in block 706, the process 700 ends. Following the process 700, a user of the attrition predictor may be aware of attrition risks for one or more employees and may take one or more actions to mitigate a risk of attrition. For example, as discussed above, the employer may provide more feedback or coaching to an employee, provide an employee with more opportunities at work, or otherwise attempt to increase an employee's satisfaction and prevent the employee from ending employment.

It should be appreciated from the foregoing that some embodiment are directed to a method for determining a likelihood that employment of an employee will end. Another embodiment is directed to at least one computer-readable storage medium (i.e., at least one tangible, non-transitory computer-readable medium) encoded with computer-executable instructions that, when executed, perform a method for determining a likelihood that employment of an employee will end. Another embodiment of the invention is directed to a system comprising at least one processor and at least one computer-readable storage medium storing processor-executable instructions that, when executed by the at least one processor, perform a method for determining a likelihood that employment of an employee will end.

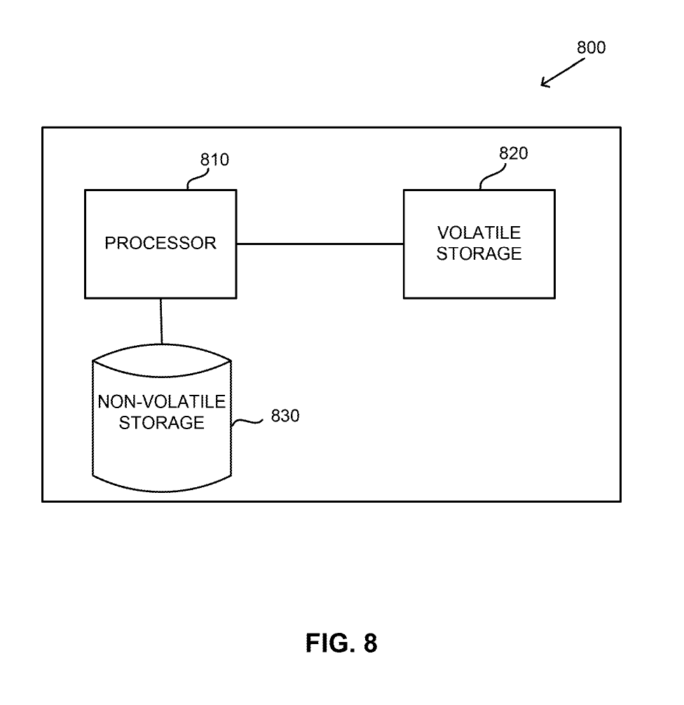

An employee management system and/or a system for determining a likelihood that employment of an employee will end in accordance with the techniques described herein may take any suitable form, as embodiments are not limited in this respect. An illustrative implementation of a computer system 800 that may be used in connection with some embodiments of the present invention is shown in FIG. 8. One or more computer systems such as computer system 800 may be used to implement any of the functionality described above. The computer system 800 may include one or more processors 810 and one or more tangible, non-transitory computer-readable storage media (e.g., volatile storage 820 and one or more non-volatile storage media 830, which may be formed of any suitable non-volatile data storage media). The processor 810 may control writing data to and reading data from the volatile storage 820 and/or the non-volatile storage device 830 in any suitable manner, as aspects of the present invention are not limited in this respect. To perform any of the functionality described herein, processor 810 may execute one or more instructions stored in one or more computer-readable storage media (e.g., volatile storage 820), which may serve as tangible, non-transitory computer-readable storage media storing instructions for execution by the processor 810.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one non-transitory computer-readable storage medium (e.g., a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing,” “involving,” and variations thereof, is meant to encompass the items listed thereafter and additional items. Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A method of determining a likelihood that employment of an employee by an employer will end, the method comprising:
operating at least one programmed processor to carry out acts of:
retrieving, from at least one data store, information regarding interaction by the employee with one or more other employees of the employer;
retrieving, from the at least one data store, information regarding performance of the employee;
calculating a numeric value indicating the likelihood that the employment of the employee will end, the calculating comprising calculating the numeric value based at least in part on the information regarding the interaction by the employee and the information regarding the performance of the employee;
comparing the numeric value to at least one threshold; and
outputting, based on a result of the comparing, a prediction of whether the employment of the employee will end.

2. The method of claim 1, wherein outputting a prediction of whether the employment of the employee will end comprises outputting a prediction of whether the employee will voluntarily end the employment.

3. The method of claim 1, wherein:
calculating the numeric score comprises weighting, by a first weighting factor, a first numeric value indicative of the interaction by the employee with the one or more other employees and weighting, by a second weighting factor, a second numeric value indicative of the performance by the employee; and
the method further comprising operating the at least one processor to carry out acts of:
receiving, from a user, input comprising the first weighting factor and the second weighting factor; and
storing the first weighting factor and the second weighting factor.

4. The method of claim 1, wherein:
the information regarding the interaction by the employee comprises a first numeric value and the information regarding the performance by the employee comprises a second numeric value; and
calculating the numeric value based at least in part on the information regarding the interaction by the employee and the information regarding the performance by the employee comprises calculating the numeric value based at least in part on the first numeric value and the second numeric value.

5. The method of claim 1, wherein retrieving the information regarding the interaction by the employee with the one or more other employees comprises collecting quantitative information regarding use by the employee of one or more computer-based productivity tools made available to employees by the employer.

6. The method of claim 5, wherein retrieving the information regarding the interaction by the employee with the one or more other employees comprises retrieving information regarding participation by the employee in at least one computer-based social network internal to the employer, the participation by the employee comprising contributing material to the at least one computer-based social network and/or reviewing material contributed to the at least one computer-based social network by the one or more employees.

7. The method of claim 6, wherein retrieving the information regarding participation by the employee in the at least one social network comprises retrieving a numeric score indicating the employee's influence with other employees of the employer, the numeric score being calculated based at least in part on quantitative information regarding the participation by the employee in the at least one computer-based social network.

8. The method of claim 1, wherein:
retrieving the information regarding the performance by the employee comprises retrieving information regarding performance ratings of the employee by other employees of the employer and/or information regarding an employee's ability to perform in the employment, the information regarding the employee's ability to perform comprising information regarding qualifications of the employee.

9. The method of claim 1, wherein:
the method further comprises operating the at least one programmed processor to carry out an act of retrieving, from at least one data store, information regarding a career path of the employee; and
calculating the numeric value comprises calculating the numeric value based at least in part on the information regarding the career of the employee.

10. The method of claim 9, wherein retrieving information regarding the career path of the employee comprises retrieving information regarding an employment history of the employee and/or information regarding one or more job opportunities for the employee, the one or more job opportunities comprising job opportunities with the employer and/or job opportunities with one or more other employers.

11. The method of claim 1, wherein:
operating the at least one programmed processor to carry out the acts comprises repeating the acts for a plurality of employees;
outputting a prediction of whether the employee will end comprises storing the prediction in association with an indication of a job profile of the employee; and
the method further comprises operating the at least one programmed processor to provide to a user an indication of a number of employees having a particular job with the employer and for which employment is predicted to end.

12. At least one computer-readable storage medium having encoded thereon computer-executable instructions that, when executed by at least one computing device, cause the at least one computing device to carry out a method, the method comprising:
calculating a numeric likelihood that an employee will voluntarily end employment with an employer, the calculating comprising:
weighting a plurality of numeric values according to a plurality of associated weighting factors to determine a plurality of weighted numeric values, and
summing the plurality of weighted numeric values,
wherein each of the plurality of numeric values relates to employment information for the employee;
comparing the numeric likelihood to a threshold; and
outputting, based on a result of the comparing, a prediction of whether the employee will end employment with the employer.

13. The at least one computer-readable storage medium of claim 12, wherein weighting the plurality of numeric values according to a plurality of associated weighting factors comprises weighting at least one numeric value that is related to a type of employment information by a weighting factor indicative of how strongly the type of employment information is predictive of employee attrition.

14. The at least one computer-readable storage medium of claim 13, wherein the method further comprises:
receiving, from a user and via a user interface, one or more of the plurality associated weighting factors.

15. The at least one computer-readable storage medium of claim 12, wherein the employment information for the employee comprises interaction information regarding interaction of the employee with one or more other employees of the employer, performance information regarding performance of the employee, and/or career path information for the employee regarding employment history and/or potential future employment of the employee.

16. The at least one computer-readable storage medium of claim 12, wherein the employment information comprises employment information relating to the employee's use of one or more computer-based productivity tools, the one or more computer-based productivity tools comprising software tools executed by one or more computing devices, the information relating to the employee's use being determined based at least in part on monitoring the employee's use.

17. An apparatus comprising:
at least one processor; and
at least one storage medium having encoded thereon executable instructions that, when executed by the at least one processor, cause the at least one processor to carry out a method, the method comprising:
calculating a numeric value indicative of a likelihood that employment of an employee by an employer will end;
comparing the numeric value to a threshold; and
outputting, based on a result of the comparing, a prediction of whether the employment by the employee will end.

18. The apparatus of claim 17, wherein the method further comprises:
monitoring the employee's use of one or more computer-based productivity tools made available to employees by the employer, wherein monitoring the employee's use comprises monitoring input provided by the employee to the one or more productivity tools via one or more computing devices, output provided by the one or more productivity tools via one or more computing devices, and/or electronic messages transmitted by the one or more productivity tools via one or more computer communication networks in response to instructions provided by the employee; and
determining employment information for the employee based at least in part on the monitoring.

19. The apparatus of claim 18, wherein determining the employment information for the employee comprises calculating one or more numeric values indicative of the employee's use of the one or more productivity tools.

20. The apparatus of claim 17, wherein calculating the numeric value indicative of a likelihood that employment of an employee by an employer will end comprises calculating the numeric value based at least in part on employment information for the employee, wherein the employment information comprises interaction information regarding interaction of the employee with one or more other employees of the employer, performance information regarding performance of the employee, and/or career path information for the employee regarding employment history and/or potential future employment of the employee.
